(19) United States
(12) Patent Application Publication
(10) Pub. No.: US 2010/0309200 A1
(43) Pub. Date: Dec. 9, 2010

(54) Method and Data Processing Appliance for the Production and for the Output of a Multidimensional Chart Having at Least Two Graphs

(75) Inventor: Tobias Bäumler, Karlsruhe (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/721,068

(22) Filed: Mar. 10, 2010

(30) Foreign Application Priority Data
Mar. 10, 2009 (EP) EP 09003499

(51) Int. Cl. G06T 15/00

(52) U.S. Cl. 345/419

(57) ABSTRACT

A method and data processing appliance for the producing and outputting a multi-dimensional chart having at least two graphs, wherein for each of the graphs which are to be presented an area between the graph and an abscissa is provided with a respective fill color or with a respective fill pattern, the graphs and the associated areas are presented in presentation planes located above one another, and wherein a respective graph and the associated area in a lower presentation plane are concealed by a graph and the associated area in a higher presentation plane. Here, the chart is produced and output in sections, wherein for each section of the abscissa a first of the graphs and the area associated with the graphs are presented using a higher value in a lower presentation plane and a second of the graphs and the associated area thereof are presented using a lower value in a higher presentation plane. As a result, each graph and a portion of its area are visible in each section.

### BACKGROUND OF THE INVENTION

The invention relates to a method and a data processing appliance for producing and outputting a multidimensional chart.

Mathematical functions, series of values from experiments or measured values are often presented in two-dimensional charts, where an abscissa is used to present a reference variable and an ordinate is used to plot the associated values, such as functional values or measured values. The resulting line is called a “graph”. Here, it is usual for the visual display of value pairs to involve the individual values being plotted as points in a chart, and then the points are then connected to one another to form a solid line so that a “solid” graph in the form of a line is obtained.

It is often a requirement for a chart with a graph to be able to be read even under difficult conditions. In such cases, the area between the graph and the abscissa is frequently presented in color or provided with a fill pattern so that an observer does not just have to orient himself to a thin line (the actual graph) but rather sees a larger object with the colored or filled area. Such a chart is also called an “area chart” or “area trend”. Such area charts are preferably used in operator control appliances for industrial automation arrangements, where important values, such as temperature curves or other process parameters, need to be presented clearly. In this case, the important parameters or values are frequently combined with one another within a single presentation, where each parameter or value has a particular color or a particular pattern for the fill area between the respective value and the abscissa (usually a time axis) permanently attributed to the parameter.

Another frequent requirement of charts is for a plurality of graphs to be presented within one and the same chart. This allows the curves of the graphs presented simultaneously with one another to be easily compared with one another. Often, the lines which are used to present the various graphs are respectively in different forms so as to allow their curves to be better distinguished. By way of example, it is thus possible for a first graph to be presented as a solid line while the next graph is presented in dashed form, etc.

Problems can arise when a plurality of graphs need to be presented together (simultaneously) within an area chart/area trend. The colored area, or the area provided with a fill pattern, of the graph presented (plotted) last or in a top presentation plane then conceals the presentation of the graph or graphs shown previously or in a lower presentation plane. This is disadvantageous in cases in which the graph presented last has higher values than a graph presented previously. Although this problem can be partially remedied by showing that graph which has the highest values first, so that this graph is only partially concealed by the subsequent graph, this produces satisfactory results only in those cases in which the graph shown last has a lower value for each point on the abscissa than a graph shown previously. If the graphs touch or cross, there are inevitably points or sections (regions) along the abscissa in which the curve of at least one the graphs is not visible because it is concealed by another graph or its fill area.

### SUMMARY OF THE INVENTION

It is therefore an object of the present invention to alter the known area charts or area trends having a plurality of graphs such that for each section of the abscissa the curve of each graph can be read.

This and other objects and advantages are achieved in accordance with the invention by providing a method for producing and outputting a multidimensional chart having at least two graphs, where for each of the graphs which are to be presented an area between the graph and an abscissa is provided with a respective fill color or with a respective fill pattern, where the graphs and the associated areas are presented in presentation planes located above one another relative to a presentation area, and where a respective graph and the associated area in a lower presentation plane are concealed by a graph and the associated area in a higher presentation plane. Here, the chart is produced and output in sections, where for each section of the abscissa a first of the graphs and the area associated with the graph are presented using a higher value (e.g., functional value or measured value) in a lower presentation plane and a second of the graphs and the associated area thereof are presented using a lower value in a higher presentation plane. The application of the method changes the graphs for each section of the abscissa in those presentation planes such that concealment is avoided. This further development of an area chart or what is know as an area trend allows a plurality of curves to be visually displayed completely within a chart/trend. As a result, it is possible to use the advantages of an area chart, such as clarity and conciseness of presentation, while at the same time retaining the advantage of a line chart, i.e., complete visibility of all graphs. The attribution of the graph elements or area elements to the respective presentation planes can be controlled by virtue of the chronological order of the production or visual display/presentation thereof being respectively re-stipulated in each of the sections.

The same advantages are also attained by a data processing appliance for the simultaneous visual display of at least two graphs within a chart, where the data processing appliance is set up for the use of the above method.

In an embodiment, the method is used for the simultaneous presentation of more than two graphs by virtue of the additional graphs which are to be presented being respectively attributed to the presentation planes on the basis of the respective value (absolute value) of said graphs, where in each section considered that graph with the highest value is presented in the bottommost presentation plane (relative to the presentation area) and that graph or graph element with the lowest value is presented in the topmost presentation plane. Consequently complete concealment of a graph or the respective associated area (e.g., fill area, pattern or hatching) does not occur.

Typically, the graphs presented by data processing appliances are produced from a succession of pixels, with the decision regarding which graph (in this case: pixel) is attributed to which presentation plane advantageously being made separately for each pixel or for each image column in the direction of the abscissa. When considered point-by-point, the “fill area” between the respective value and the abscissa is reduced to a line, the length of which corresponds to the respective value. So as nevertheless to be able to present a fill area as a pattern or hatching, cohesive areas or area elements can be provided with a pattern or with hatching, according to the requirements, following the production of the chart; this handling step is also called “rendering”. As an alternative to the point-by-point consideration, the graphs can also be examined in respect of their points of contact or intersection with one another, where the regions of the abscissa which are situated between the points of intersection are respectively stipulated as a section.

A frequent instance of application for area charts is covered by the method if it is used for a data processing appliance in the form of an operator control appliance for an industrial automation arrangement, where the method is advantageously set up to present processing and control parameters or to present measured values. Similarly, the method can advantageously be used for a data processing appliance which is used for the visual display of series of values from spreadsheet programs or measured value capture programs.

To consider a selected instance of the graphs more accurately, it is simply possible to change over to a complete presentation of the graph or the area thereof by using a selection means, for example, a computer mouse with a mouse pointer, being provided for the data processing appliance, where “clicking” on an individual area element is sufficient to display an associated graph completely in the topmost presentation plane. Advantageously, the area of this graph, which is displayed in this case, may appear in a partial transparent presentation, so that the curves of the other graphs continue to be visible. Instead of a computer mouse and a mouse pointer, the data processing appliance may also have a touch-sensitive screen (“touch screen”), where tapping an appropriate area or area element is sufficient for selection.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the method in accordance with the invention and hence also of the data processing appliance in accordance with the invention are explained below with reference to the drawings, in which:

FIGS. 1, 2 and 3 show three area charts with a respective single graph;

FIG. 4 shows a prior art area chart in which the graphs in FIGS. 1, 2 and 3 are presented in combination with one another;

FIG. 5 shows the combined presentation of the graphs from FIGS. 1, 2 and 3 based on the method in accordance with an embodiment of the invention; and

FIG. 6 is shows a schematic block diagram of a data processing appliance in accordance with an embodiment of the invention.

### DETAILED DESCRIPTION OF THE PREFERRED EMBODIMENTS

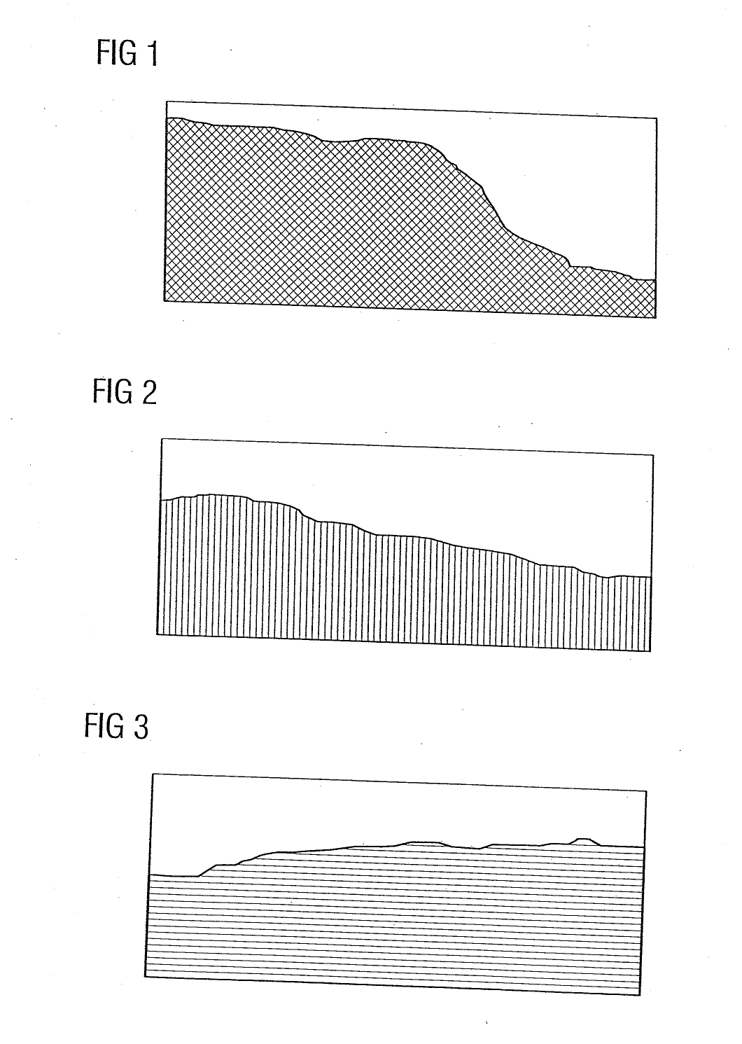

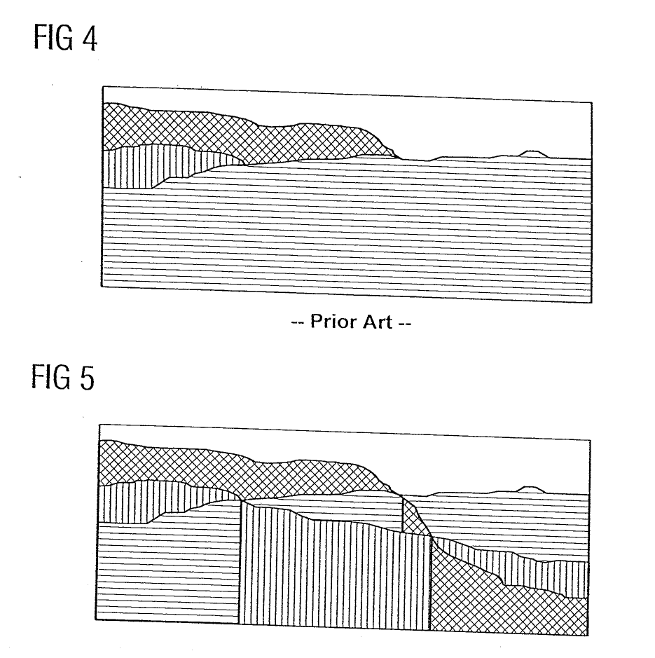

FIGS. 1, 2 and 3 each show a respective graph, where the respective area between the graph and the abscissa (in the figures the respective lower edge of the presentation is the abscissa) and the respective value (the actual graph, e.g., functional value or measured value) is filled with the respective fill pattern. While the area of the graph is cross-hatched in FIG. 1, the area for the graph from FIG. 2 is vertically hatched and the area for the graph from FIG. 3 is horizontally hatched. It should be understood that the area graphs in FIGS. 1, 2 and 3 can also be presented using different colors or different grayscales or a combination thereof instead of the hatchings.

It will subsequently be assumed that the graphs from FIGS. 1, 2 and 3 are intended to be presented simultaneously within a single area chart. Using a method based on the prior art, the graphs with the associated areas are shown successively in one and the same chart, with it either being left to chance or else being stipulated otherwise which of the graphs is shown first and which of the graphs is shown last, as a result of which the attribution of the graphs with the associated areas to the presentation planes is stipulated. In the example in FIG. 4, which shows the resultant chart using a prior art method, the graph with the associated area from FIG. 1 has been shown first, followed by the presentation from FIG. 2 and finally the presentation from FIG. 3 in the resulting chart. It can be seen that, in the first third of the chart (as seen from the left-hand side), all three graphs from the individual charts are still shown, while in a central region of the chart the portion coming from FIG. 2 is already no longer visible, whereas the right-hand third of the chart now shows only the portion coming from FIG. 3, because the other two portions are concealed by this portion.

FIG. 5 shows the same combination of graphs from FIGS. 1, 2 and 3, but with the order in which the graph elements are visually displayed being respectively redefined in sections, so that for each section of the abscissa the graph with the highest values is shown first and hence is attributed to the bottommost presentation plane, and that graph with the lowest values is shown last and hence is attributed to the topmost (highest) presentation plane. In the first section of the chart (left-hand side of the image) this means that first of all the graph from FIG. 1, then the graph from FIG. 2 and finally the graph from FIG. 3 are considered. At the point at which the graphs from FIGS. 2 and 3 cross, this order changes, so that the graph which has the lowest values in this section is presented in the foreground. This is now the graph from FIG. 2. The decision regarding which of the graphs is shown in which presentation plane changes whenever at least two of the graphs intersect, that is to say where these “cross”. When using a data processing program which constructs the presentation point-by-point, this decision can also be made again for each “column of the image” with the width of a pixel, however. The method is now continued until (at the right-hand edge of the image) the graph from FIG. 3 is finally attributed to the bottommost presentation plane, and the graph from FIG. 1 is attributed to the topmost (highest) presentation plane. As a result, in each section of the abscissa the graphs are presented in the form of an area chart, with complete concealment being avoided in every case.

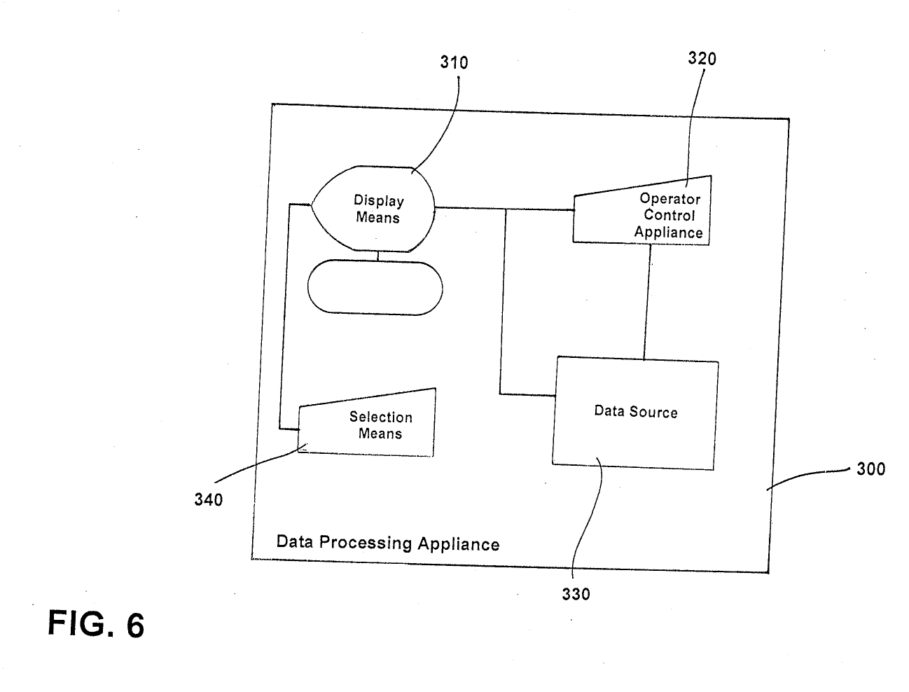

FIG. 6 is a schematic illustration of a data processing appliance 300 for the simultaneous visual display of a plurality of graphs within a chart in accordance with an embodiment of the invention. In accordance with the invention, the data processing appliance 300 is configured to provide an area between each of the plurality of graphs and an abscissa with a respective fill color or with a respective fill pattern for each of the plurality of graphs which are to be presented, present each of the plurality of graphs and associated areas in presentation planes located above one another relative to a presentation area, conceal a first graph of the plurality of graphs and an associated area in a lower presentation plane by another graph of said plural graphs and the associated area in a higher presentation plane and is configured to produce and output the multi-dimensional chart in sections. In accordance with the invention, the first graph of the plurality of graphs and the area associated with the first graph are presented using a higher value in a lower presentation plane for each section of the abscissa, and the second graph of the plurality of graphs and the area associated with the second graph are presented using a lower value in the higher presentation plane.

In an embodiment, the data appliance 300 comprises an operator control appliance 320 for an industrial automation arrangement, where the operator control appliance 320 is configured to present process and control parameters or to present measured values.

In another embodiment, the data processing appliance 300 visually displays a plurality of series of values obtained from a spreadsheet or another data source 330 on a display means 310.

In yet another embodiment, the data processing appliance 300 includes a selection means 340 for selecting at least one area or area element of each of the plurality of presented graphs. Here, the data processing appliance is further configured to complete presentation of that graph and the associated area thereof, where the at least one area or area element of being selected by the selection means. In accordance with the disclosed embodiment, the selection means 340 comprises a cursor that is moved by a computer mouse or selected by a touch-sensitive screen.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A method for producing and outputting a multi-dimensional chart having a plurality of graphs, comprising:
providing, by a data processing appliance, an area between each of said plural graphs and an abscissa with a respective fill color or with a respective fill pattern for each of said plural graphs which are to be presented;
presenting each of said plural graphs and associated areas in at least first and second presentation planes located above one another relative to a presentation area, one of the first and second of said plural graphs with an associated area in a lower one of the first and second presentation planes being concealed by another graph of said plural graphs with an associated area in a higher one of the first and second presentation planes; and
producing and outputting the multi-dimensional chart in sections of the abscissa within each said sections, a first graph of said plural graphs having a higher value and the area associated with the first graph are presented in the lower presentation plane, and a second graph of said plural graphs having a lower value and the area associated with the second graph are presented in the higher presentation plane.

2. The method as claimed in claim 1, wherein the method comprises presenting at least one third graph;
for each of the at least one third graph a further presentation plane is inserted;
in the each of the sections of the abscissa, graphs which are to be presented and their associated areas are respectively attributed to one of the first, second, and further presentation planes; and
in the each of the sections, the first, second, and at least one third graphs are respectively presented in the presentation planes from the highest one of the presentation planes to the lowest one of the presentation planes in ascending order of values of the first, second and at least one third graphs and the presentation of the lower ones of the presentation planes are respectively concealed by the graphs and areas of the higher ones of the presentation planes.

3. The method as claimed in claim 1, wherein said plural graphs and each associated area are respectively presented by pixels, a width used for each section of the abscissa comprises the width of the pixel and wherein each value of the abscissa is attributed to precisely one section.

4. The method as claimed in claim 2, wherein said plural graphs and each associated area are respectively presented by pixels, a width used for each section of the abscissa comprises the width of the pixel and wherein each value of the abscissa is attributed to precisely one section.

5. A data processing appliance for the simultaneous visual display of a plurality of graphs within a chart, the appliance comprising a control appliance and a display for displaying the plurality of graphs, wherein the data processing appliance is configured to:
provide an area between each of said plural graphs and an abscissa with a respective fill color or with a respective fill pattern for each of said plural graphs which are to be presented;
present each of said plural graphs and associated areas in at least first and second presentation planes located above one another relative to a presentation area, one of said plural graphs with an associated area in a lower one of the first and second presentation planes being concealed by another graph of said plural graphs with an associated area in a higher one of the first and second presentation planes; and
produce and output, on the display, the multi-dimensional chart in sections of the abscissa within each said sections, a first graph of said plural graphs having a higher value and the area associated with the first graph are presented in the lower presentation plane for each section of the abscissa, and a second graph of said plural graphs having a lower value and the area associated with the second graph are presented in the higher presentation plane.

6. The data processing appliance as claimed in claim 5, wherein the control appliance comprises an operator control appliance for an industrial automation arrangement, and wherein the operator control appliance is configured to present process and control parameters or to present measured values.

7. The data processing appliance as claimed in claim 5, wherein the display of the data processing appliance visually displays a plurality of series of values obtained from a spreadsheet or another data source.

8. The data processing appliance as claimed in claim 6, wherein the display of the data processing appliance visually displays a plurality of series of values obtained from a spreadsheet or another data source.

9. The data processing appliance as claimed in claim 5, wherein the data processing appliance includes a selection means for selecting at least one area or area element of one of said plural presented graphs; and wherein the data processing appliance is configured to present a complete presentation of the one of said plural presented graphs, and the associated area thereof, of which the selection means has selected the at least one area or area element.

10. The data processing appliance as claimed in claim 6, wherein the data processing appliance includes a selection means for selecting at least one area or area element of one of said plural presented graphs; and wherein the data processing appliance is configured to present a complete presentation of the one of said plural presented graphs, and the associated area thereof, of which the selection means has selected the at least one area or area element.

11. The data processing appliance as claimed in claim 7, wherein the data processing appliance includes a selection means for selecting at least one area or area element of one of said plural presented graphs; and wherein the data processing appliance is configured to present a complete presentation of the one of said plural presented graphs, and the associated area thereof, of which the selection means has selected the at least one area or area element.

12. The data processing appliance as claimed in claim 9, wherein the selection means comprises a cursor moved by a computer mouse or selected by a touch-sensitive screen.

13. The data processing appliance as claimed in claim 9, wherein the data processing appliance is configured to complete presentation of a selected one of the graphs in a topmost presentation plane and present the other graphs in underlying presentation planes.

14. The data processing appliance as claimed in claim 12, wherein the data processing appliance is configured to complete presentation of a selected one of the graphs in a topmost presentation plane and present the other graphs in underlying presentation planes.
